(19) United States
(12) Patent Application Publication
(10) Pub. No.: US 2026/0237734 A1
(43) Pub. Date: Aug. 13, 2026

(54) NEW Li-CONDUCTOR PROTOTYPES IN THE Li-In-Na-Cl CHEMICAL SPACE FOR SOLID-STATE BATTERIES

(71) Applicant: SAMSUNG ELECTRONICS CO., LTD., Suwon-si (KR)

(72) Inventors: Qingjie LI, Arlington, MA (US); Chuhong Wang, Lexington, MA (US); Zijian Cai, Cambridge, MA (US); Yan Wang, Brookline, MA (US)

(73) Assignee: SAMSUNG ELECTRONICS CO., LTD., Suwon-si (KR)

(21) Appl. No.: 19/203,780

(22) Filed: May 9, 2025

Related U.S. Application Data
(60) Provisional application No. 63/757,021, filed on Feb. 11, 2025.

(51) Int. Cl. H01M 10/0562; H01M 10/0525

(52) U.S. Cl. CPC H01M 10/0562; H01M 10/0525; H01M 2300/008

(57) ABSTRACT

A lithium-containing compound is selected from LiNa₄InCl₈, LiNa₂InCl₆, Li₂Na₃InCl₈, Li₂NaInCl₆ and Li₄NaInCl₈. The lithium-containing compound can be used as a solid electrolyte in a Li solid-state battery and also as a coating for an electrode in a solid-state battery. In an embodiment, a lithium solid-state battery includes a cathode active material layer, an anode active material layer, and a solid electrolyte layer between the cathode active material layer and the anode active material layer, wherein the solid electrolyte layer includes the aforementioned lithium-containing compound. In an embodiment, the battery includes the aforementioned lithium-containing compound as a coating for an electrode.

### CROSS-REFERENCE TO RELATED APPLICATION

This application is based on and claims priority from U.S. Provisional Application No. 63/757,021 filed on Feb. 11, 2025 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and also as coatings for electrodes in solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. A liquid electrolyte-containing lithium ion battery and a solid state battery are shown in FIG. 1. Conventional lithium ion batteries provide high energy and power density, have a long cycle life, and have no memory effect, but they have a safety issue due to a flammable liquid electrolyte. In contrast, solid-state lithium ion batteries have safety advantages, provide higher energy density, provide more freedom in battery geometry, and have more possibilities in electrode materials, including metallic lithium as the anode.

A key component in SSBs is the solid electrolyte material. Commercialization of SSBs crucially depends on the success of new solid electrolyte materials.

Solid-state lithium-ion conductors with high ionic conductivities play an important role in SSBs. During the past two decades, there has been an increasing amount of work on discovering new solid-state lithium-ion conductors (SSLICs), including various oxide, sulfide, and halide materials. And most of them are focused on sulfide SSLICs with high ionic conductivities. Halide materials are believed to simultaneously show high Li ion conductivity and deformability. However, a very limited number of chloride materials were developed for SSBs.

Meanwhile, commercialization of SSBs crucially depends on the success of new solid electrolyte materials.

FIG. 2 shows the relative strengths and weaknesses of oxide, sulfide, and halide materials as solid-state electrolytes, as discussed in further detail below.

For solid-state electrolytes in SSBs, sulfide-based materials have high ionic conductivities (>10 mS/cm) but are not really safe (H₂S in air condition) and have limited electrochemical stability (for example, unstable against Li metal).

Oxide SSLICs, which show better electrochemical and chemical stability than sulfide SSLICs, have been largely limited in garnet-type materials. The ionic conductivities of reported oxide SSLICs are generally lower than those of sulfide SSLICs. Also, oxide SSLICs show relatively poor deformability which is crucial for processing and cycling performance.

Halide SSLICs are believed to show both high ionic conductivity and deformability, and reasonable electrochemical stability. Therefore, discovering new halide SSLICs is a promising solution for successful application of SSBs.

Solid state electrolyte materials with superionic conductivity and good deformability are desirable materials to form all-solid-state Li-metals batteries. However, it remains a significant challenge to simultaneously achieve high ionic conductivity at room temperature, good deformability for processing, and high electrochemical stability. Competition with currently established liquid electrolyte technologies is also a hurdle for widespread adoption. Currently, no Li-ion solid conductors satisfying all the above-mentioned requirements have been uncovered in the Li—Ca—Na—Cl chemical space. This disclosure focuses on a new composition in the Li—Ca—Na—Cl chemical space.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Ca—Na—Cl chemical space by high-throughput searching of novel structures using machine learning based evolutionary algorithms.

In this disclosure, novel lithium-containing chlorides have a parent formula selected from the group consisting of LiNa₄InCl₈, LiNa₂InCl₆, Li₂Na₃InCl₈, Li₂NaInCl₆ and Li₄NaInCl₈.

The lithium-containing compounds in this disclosure can be used as a solid electrolyte material for Li batteries. In addition, the lithium-containing compounds can be used as a coating for an electrode (i.e., a coating for a cathode or an anode).

This disclosure provides a high conductivity and good deformability solid electrolyte for use in Li solid-state batteries.

A first embodiment of the present disclosure provides a lithium-containing compound selected from the group consisting of LiNa₄InCl₈, LiNa₂InCl₆, Li₂Na₃InCl₈, Li₂NaInCl₆ and Li₄NaInCl₈.

A second embodiment of the present disclosure provides a lithium-containing compound of the first embodiment, wherein the lithium-containing compound is LiNa₄InCl₈.

A third embodiment of the present disclosure provides a lithium-containing compound of the first embodiment, wherein the lithium-containing compound is LiNa₄InCl₈ crystallized in space group R-3 or P1.

A fourth embodiment of the present disclosure provides a lithium-containing compound of the first embodiment, wherein the lithium-containing compound is LiNa₂InCl₆.

A fifth embodiment of the present disclosure provides a lithium-containing compound of the first embodiment, wherein the lithium-containing compound is LiNa₂InCl₆ crystallized in space group P-3 or P-31m.

A sixth embodiment of the present disclosure provides a lithium-containing compound of the first embodiment, wherein the lithium-containing compound is Li₂Na₃InCl₈.

A seventh embodiment of the present disclosure provides a lithium-containing compound of the first embodiment, wherein the lithium-containing compound is Li₂Na₃InCl₈ crystallized in space group P1 or P2.

An eighth embodiment of the present disclosure provides a lithium-containing compound of the first embodiment, wherein the lithium-containing compound is Li₂NaInCl₆.

A ninth embodiment of the present disclosure provides a lithium-containing compound of the first embodiment, wherein the lithium-containing compound is Li₂NaInCl₆ crystallized in space group P1, C2/m, R-3, or P6₃/m.

A tenth embodiment of the present disclosure provides a lithium-containing compound of the first embodiment, wherein the lithium-containing compound is Li₄NaInCl₈.

An eleventh embodiment of the present disclosure provides a lithium-containing compound of the first embodiment, wherein the lithium-containing compound is Li₄NaInCl₈ crystallized in space group Cm, Immm, P-1, or P1.

A twelfth embodiment of the present disclosure provides a lithium solid-state battery comprising a cathode active material layer, an anode active material layer, and a solid electrolyte layer between the cathode active material layer and the anode active material layer, wherein the solid electrolyte layer comprises a lithium-containing compound of the first embodiment.

A thirteenth embodiment of the present disclosure provides a lithium solid-state battery of the twelfth embodiment, wherein the solid electrolyte layer comprises a lithium-containing compound which is LiNa₄InCl₈ crystallized in space group R-3 or P1.

A fourteenth embodiment of the present disclosure provides a lithium solid-state battery of the twelfth embodiment, wherein the solid electrolyte layer comprises a lithium-containing compound which is LiNa₂InCl₆ crystallized in space group P-3 or P-31m.

A fifteenth embodiment of the present disclosure provides a lithium solid-state battery of the twelfth embodiment, wherein the solid electrolyte layer comprises a lithium-containing compound which is Li₂NaInCl₈ crystallized in space group P1 or P2.

A sixteenth embodiment of the present disclosure provides a lithium solid-state battery of the twelfth embodiment, wherein the solid electrolyte layer comprises a lithium-containing compound which is Li₂NaInCl₆ crystallized in space group P1, C2/m, R-3, or P6₃/m.

A seventeenth embodiment of the present disclosure provides a lithium solid-state battery of the twelfth embodiment, wherein the solid electrolyte layer comprises a lithium-containing compound which is Li₂NaInCl₆ crystallized in space group Cm, Immm, P-1, or P1.

An eighteenth embodiment of the present disclosure provides a lithium solid-state battery comprising a cathode active material layer, an anode active material layer, and a solid electrolyte layer between the cathode active material layer and the anode active material layer, wherein the battery comprises a lithium-containing compound of the first embodiment as a coating for the cathode active material layer.

A nineteenth embodiment of the present disclosure provides a lithium solid-state battery comprising a cathode active material layer, an anode active material layer, and a solid electrolyte layer between the cathode active material layer and the anode active material layer, wherein the battery comprises a lithium-containing compound of the first embodiment as a coating for the anode active material layer.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawing in which:

FIG. 1 shows a liquid electrolyte-containing lithium ion battery and a solid state battery.

FIG. 2 shows the relative strengths and weaknesses of oxide, sulfide, and halide materials as solid-state electrolytes.

FIG. 3 shows the crystal structures of exemplary embodiments of the present disclosure, including LiNa₄InCl₈ crystallized in space group R-3, LiNa₂InCl₆ crystallized in space group P-3, Li₂Na₃InCl₈ crystallized in space group P2, Li₂NaInCl₆ crystallized in space group P6₃/m, and Li₄NaInCl₈ crystallized in space group Immm.

FIG. 4 shows graphs including the diffusivity of Lit vs. Nat in various materials of the present disclosure, with the graphs showing mean square displacement vs. time.

FIGS. 5A-5D show larger versions of the subfigures of FIG. 4.

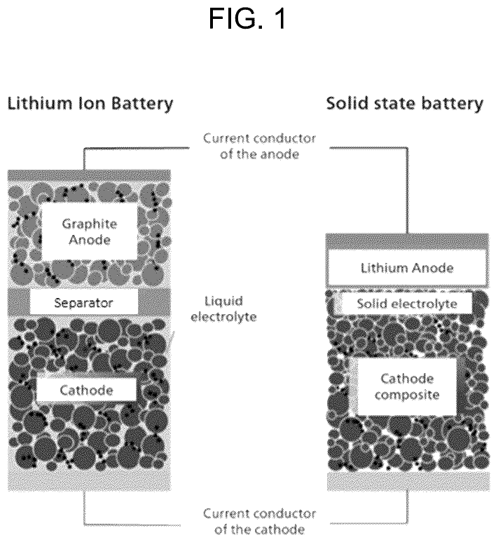

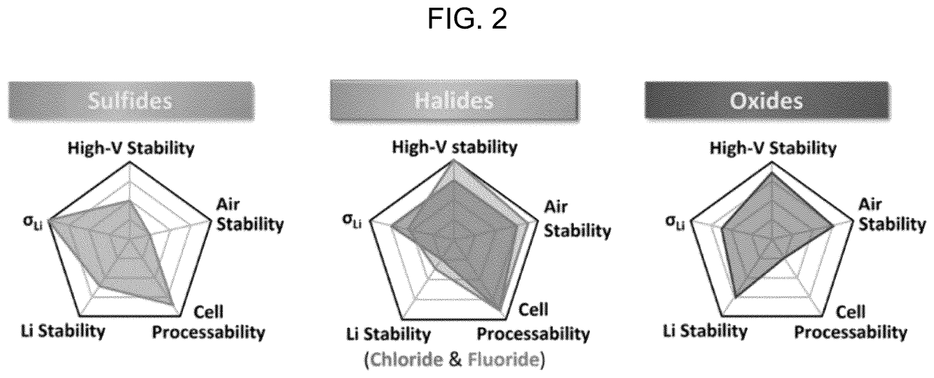

### DETAILED DESCRIPTION OF EXAMPLE EMBODIMENTS

The present disclosure focuses on presenting structure prototypes of highly conductive and deformable Li-conductors of all-solid-state Li-metal batteries in the Li—In—Na—Cl chemical space by applying a machine learning force field based evolutionary algorithm.

In particular, a high-throughput evolutionary algorithm based materials search was conducted to discover novel prototypes for deformable Li-ion conductors as a potential solid electrolyte in an all solid Li-ion battery. The discovered novel prototype structures have been validated against thermodynamic stability, Li-ion conductivity at room temperature, and its deformability.

The present disclosure demonstrates novel compositions (crystal structures) within the Li—In—Na—Cl chemical space with high Li-ion conductivity and good deformability.

Thus, in this disclosure, novel Li-ion prototypes within the Li—In—Na—Cl chemical space include LiNa₄InCl₈, LiNa₂InCl₆, Li₂Na₃InCl₈, Li₂NaInCl₆ and Li₄NaInCl₈ with Li content from 7% to 29% (compositional percent based on number of atoms). These materials may crystallize in distinct crystal systems including: trigonal, monoclinic, hexagonal, and orthorhombic. These structures show reasonable thermodynamic (meta) stability with energy above hull less than 52 meV/atom.

The disclosed materials show high predicted ionic conductivities ranges from 1-30 mS/cm at room temperature.

Also, the disclosed materials are predicted to show low hardness of <4.0 GPa, indicating good deformability.

The new Li-ion conductor prototype LiNa₄InCl₈ may crystallize in the following distinct space groups: R-3 or P1, the new Li-ion conductor prototype LiNa₂InCl₆ may crystallize in the following distinct space groups: P-3 or P-31m, the new Li-ion conductor prototype Li₂Na₃InCl₈ may crystallize in the following distinct space groups: P1 or P2, the new Li-ion conductor prototype Li₂NaInCl₆ may crystallize in the following distinct space groups: P1, C2/m, R-3, or P6₃/m, and the new Li-ion conductor prototype Li₄NaInCl₈ may crystallize in the following distinct space groups: Cm, Immm, P-1, or P1.

Thus, the new compositions may crystallize in the crystal structures shown in Table 1 below, each with high Li-ion conductivity and good deformability.

TABLE 1

| | | | | | | Electrochemical | |
|---|---|---|---|---|---|---|---|
| | | space | E hull | σ (300K) | Eₐ | Stability Window | Hardness |
| Material_id | formula | group | (meV/atom) | (mS/cm) | (eV) | vs. Li/Li+ (V) | (GPa) |
| aml-02-166846 | Na4LiInCl8 | R-3 | 41.4 | 3.98 | 0.23 | 2.19~3.8 | 0.8 |
| aml-07-402998 | Na4LiInCl8 | P1 | 47.4 | 0.655 | 0.32 | 2.19~3.8 | 0.75 |
| aml-07-404540 | Na2LiInCl6 | P-3 | 22.3 | 51.17 | 0.15 | 2.28~4.07 | 0.74 |
| aml-07-408391 | Na2LiInCl6 | P-31m | 49.5 | 4.96 | 0.23 | 2.28~4.07 | 0.81 |
| aml-02-166286 | Na3Li2InCl8 | P1 | 51.5 | 20.254 | 0.16 | 2.19~3.82 | 0.75 |
| aml-07-403577 | Na3Li2InCl8 | P2 | 37 | 3.16 | 0.27 | 2.19~3.82 | 0.84 |
| aml-02-165380 | NaLi2InCl6 | P1 | 1.2 | 30.34 | 0.2 | 2.28~4.07 | 0.98 |
| aml-02-167200 | NaLi2InCl6 | C2/m | 0.7 | 1.479 | 0.35 | 2.28~4.07 | 0.92 |
| aml-02-167188 | NaLi2InCl6 | R-3 | 3.4 | 3.453 | 0.3 | 2.28~4.07 | 1.06 |
| aml-02-167487 | NaLi2InCl6 | P6_3/m | 7.4 | 6.006 | 0.27 | 2.28~4.07 | 0.92 |
| aml-02-165834 | NaLi4InCl8 | Cm | 28.9 | 8.646 | 0.25 | 2.28~3.82 | 1.03 |
| aml-07-403365 | NaLi4InCl8 | Immm | 41 | 16.423 | 0.19 | 2.28~3.82 | 0.96 |
| aml-07-408315 | NaLi4InCl8 | P-1 | 34.7 | 42.908 | 0.18 | 2.28~3.82 | 0.73 |
| aml-07-409324 | NaLi4InCl8 | P1 | 38.4 | 36.13 | 0.22 | 2.28~3.82 | 0.84 |

Note: Eₐ is the Li-ion diffusion activation energy, and σ is the Li-ion conductivity; hardness is a good indicator of deformability.

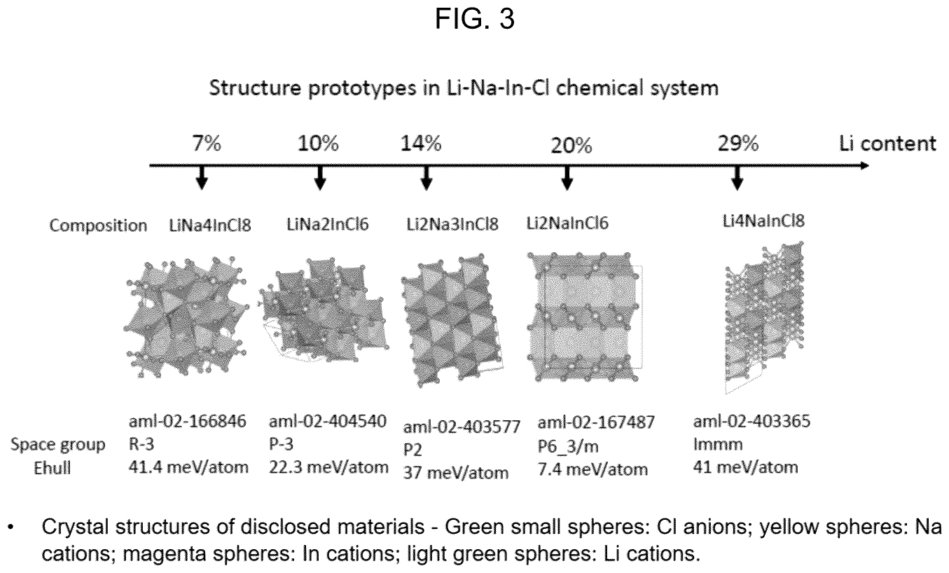

Exemplary embodiments of the present disclosure are shown in FIG. 3. In particular, the crystal structures of materials of the present disclosure with the formula LiNa₄InCl₈ crystallized in space group R-3, LiNa₂InCl₆ crystallized in space group P-3, Li₂Na₃InCl₈ crystallized in space group P2, Li₂NaInCl₆ crystallized in space group P6₃/m, and Li₄NaInCl₈ crystallized in space group Immm are shown in FIG. 3. In FIG. 3, the green small spheres are Cl anions, the yellow spheres are Na cations, the magenta spheres are In cations, and the light green spheres are Li cations.

The calculated powder diffraction pattern for LiNaCa₂Cl₆ crystallized in space group Cm is shown in FIG. 3A, the calculated powder diffraction pattern for LiNaCa₂Cl₆ crystallized in space group P3 is shown in FIG. 3B, and the calculated powder diffraction pattern for LiNaCa₂Cl₆ crystallized in space group P2 is shown in FIG. 3C.

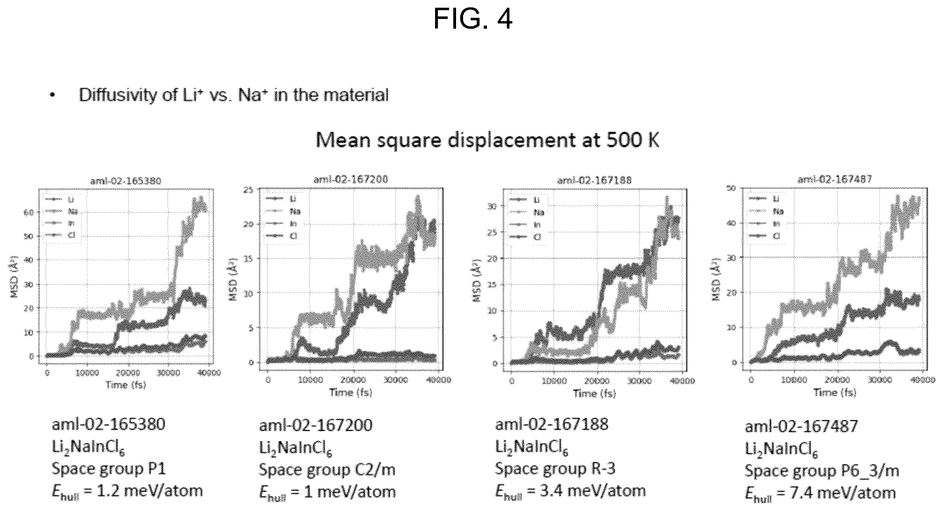

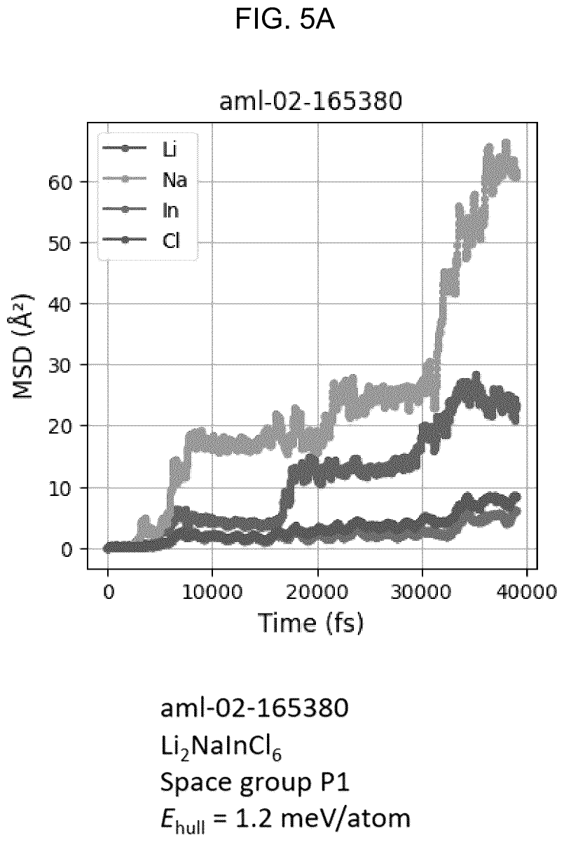

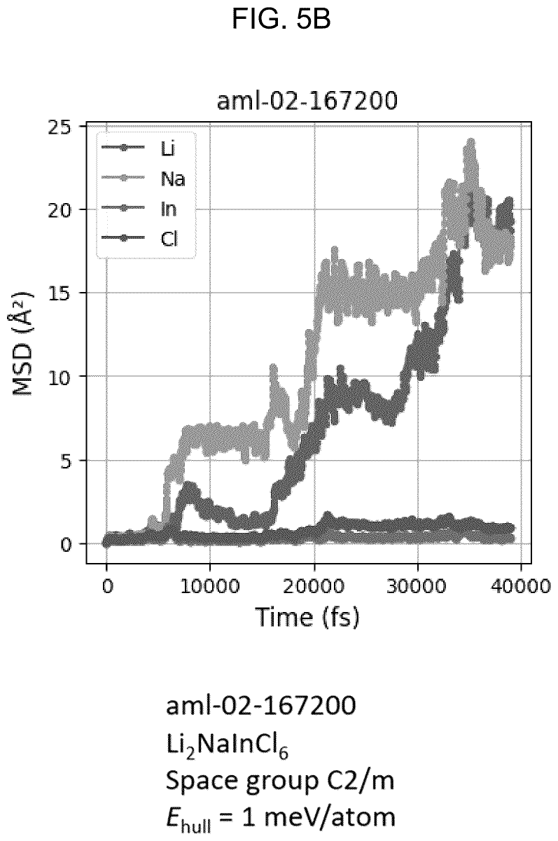

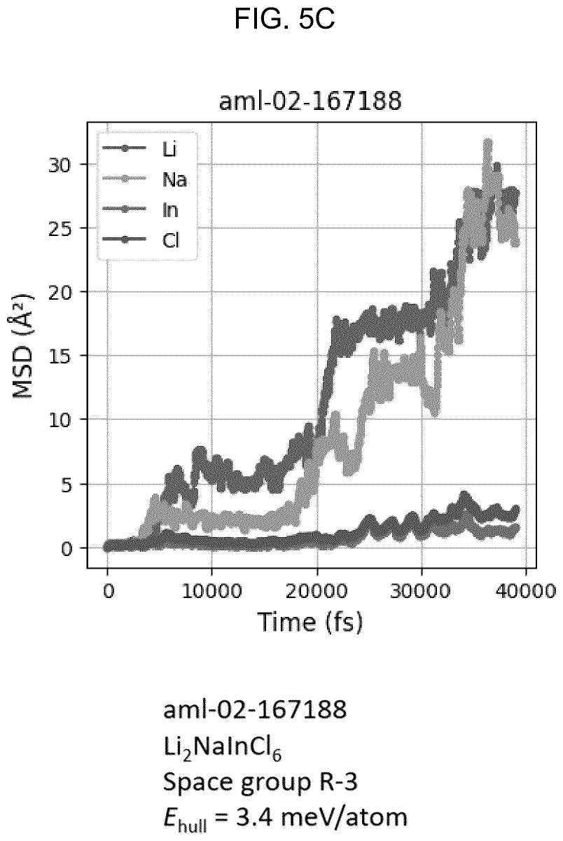

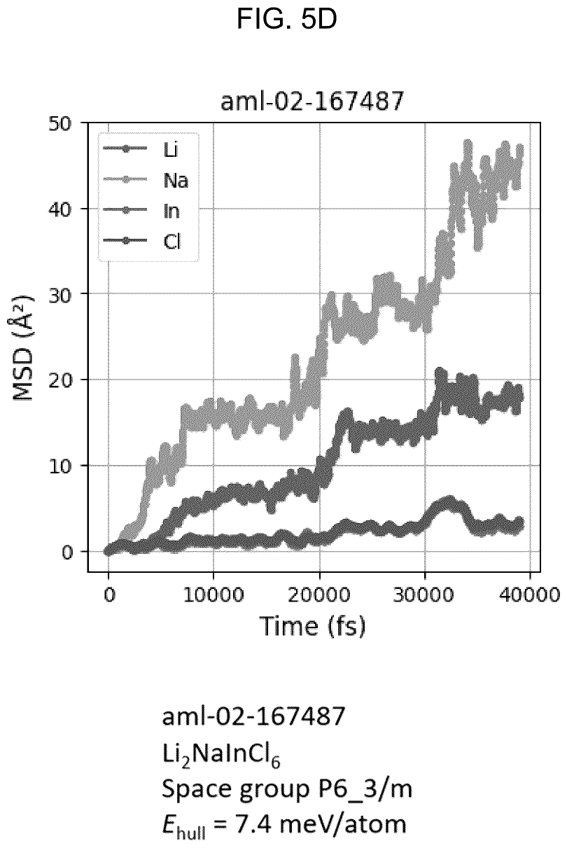

FIG. 4 shows graphs including the diffusivity of Li⁺ vs. Na⁺ in various materials of the present disclosure, with the graphs showing mean square displacement vs. time for Li₂NaInCl₆ crystallized in space group P1, Li₂NaInCl₆ crystallized in space group C2/m, Li₂NaInCl₆ crystallized in space group R-3, and Li₂NaInCl₆ crystallized in space group P6₃/m. FIGS. 5A-5D show larger versions of the subfigures of FIG. 4, with FIG. 5A showing a graph of mean square displacement vs. time for Li₂NaInCl₆ crystallized in space group P1, FIG. 5B showing a graph of mean square displacement vs. time for Li₂NaInCl₆ crystallized in space group C2/m, FIG. 5C showing a graph of mean square displacement vs. time for Li₂NaInCl₆ crystallized in space group R-3, and FIG. 5D showing a graph of mean square displacement vs. time for Li₂NaInCl₆ crystallized in space group P6₃/m.

The lithium-containing compounds in this disclosure can be made by a standard solid-state or mechanochemical ball-milling method.

In this method, precursor powders are combined in a certain ratio depending on the composition of the target material. As one example, precursors may consist of lithium chloride (LiCl), sodium chloride (NaCl), and indium chloride (InCl₃).

The precursor mixture may be mixed by a method such as ball milling or planetary milling to produce a homogeneous mixture. Mixing may be done with a suitable solvent such as ethanol, isopropanol, ethylene glycol, hexane, or acetone to assist with the uniform dispersion of the precursors.

The precursor mixture may then be heat treated to an appropriate temperature (e.g., 300-1000° C., or 500-1000° C.) for an appropriate period of time (e.g., 1-24 hours, or 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., up to 1 hour, or 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing chlorides in this disclosure can be used, for example, as a solid electrolyte material for Li batteries. The lithium-containing compounds in this disclosure can also be used as a coating for an electrode (i.e., a coating for a cathode or an anode).

In particular, this disclosure provides, for example, high conductivity and good deformability solid electrolytes for use in Li solid-state batteries.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing compound selected from the group consisting of LiNa₄InCl₈, LiNa₂InCl₆, Li₂Na₃InCl₈, Li₂NaInCl₆ and Li₄NaInCl₈.

2. The lithium-containing compound of claim 1, wherein the lithium-containing compound is LiNa₄InCl₈.

3. The lithium-containing compound of claim 1, wherein the lithium-containing compound is LiNa₄InCl₈ crystallized in space group R-3 or P1.

4. The lithium-containing compound of claim 1, wherein the lithium-containing compound is LiNa₂InCl₆.

5. The lithium-containing compound of claim 1, wherein the lithium-containing compound is LiNa₂InCl₆ crystallized in space group P-3 or P-31m.

6. The lithium-containing compound of claim 1, wherein the lithium-containing compound is Li₂Na₃InCl₈.

7. The lithium-containing compound of claim 1, wherein the lithium-containing compound is Li₂Na₃InCl₈ crystallized in space group P1 or P2.

8. The lithium-containing compound of claim 1, wherein the lithium-containing compound is Li₂NaInCl₆.

9. The lithium-containing compound of claim 1, wherein the lithium-containing compound is Li₂NaInCl₆ crystallized in space group P1, C2/m, R-3, or P6₃/m.

10. The lithium-containing compound of claim 1, wherein the lithium-containing compound is Li₄NaInCl₈.

11. The lithium-containing compound of claim 1, wherein the lithium-containing compound is Li₄NaInCl₈ crystallized in space group Cm, Immm, P-1, or P1.

12. A lithium solid-state battery comprising a cathode active material layer, an anode active material layer, and a solid electrolyte layer between the cathode active material layer and the anode active material layer, wherein the solid electrolyte layer comprises a lithium-containing compound of claim 1.

13. The lithium solid-state battery of claim 12, wherein the solid electrolyte layer comprises a lithium-containing compound which is LiNa₄InCl₈ crystallized in space group R-3 or P1.

14. The lithium solid-state battery of claim 12, wherein the solid electrolyte layer comprises a lithium-containing compound which is LiNa₂InCl₆ crystallized in space group P-3 or P-31m.

15. The lithium solid-state battery of claim 12, wherein the solid electrolyte layer comprises a lithium-containing compound which is Li₂Na₃InCl₈ crystallized in space group P1 or P2.

16. The lithium solid-state battery of claim 12, wherein the solid electrolyte layer comprises a lithium-containing compound which is Li₂NaInCl₆ crystallized in space group P1, C2/m, R-3, or P6₃/m.

17. The lithium solid-state battery of claim 12, wherein the solid electrolyte layer comprises a lithium-containing compound which is Li₂NaInCl₆ crystallized in space group Cm, Immm, P-1, or P1.

18. A lithium solid-state battery comprising a cathode active material layer, an anode active material layer, and a solid electrolyte layer between the cathode active material layer and the anode active material layer, wherein the battery comprises a lithium-containing compound of claim 1 as a coating for the cathode active material layer.

19. A lithium solid-state battery comprising a cathode active material layer, an anode active material layer, and a solid electrolyte layer between the cathode active material layer and the anode active material layer, wherein the battery comprises a lithium-containing compound of claim 1 as a coating for the anode active material layer.
